(19) United States
(12) Patent Application Publication
(10) Pub. No.: US 2012/0134433 A1
(43) Pub. Date: May 31, 2012

(54) METHOD AND SYSTEM OF ENHANCED PERFORMANCE IN COMMUNICATION SYSTEMS

(76) Inventors: Harald Haas, Edinburgh (GB); Raed Meseh, Tabuk (SA); Irina Stefan, Brernen (DE); Peter Mitchell Grant, Edinburgh (GB)

(21) Appl. No.: 13/201,986

(22) PCT Filed: Feb. 17, 2010
(86) PCT No.: PCT/GB10/50262

§ 371 Date: Oct. 6, 2011

(30) Foreign Application Priority Data
Feb. 18, 2009 (GB) 0902701.2

(51) Int. Cl. H04L 5/12; H04L 1/00

(52) U.S. Cl. 375/262; 375/260; 375/265

(57) ABSTRACT

A method of spatial modulation to identify a transmitter within a transmission array, wherein the transmitter has a unique bit sequence and defines a spatial component indicative of relative location is disclosed, comprising the following steps: receiving transmitted bits from the transmission array and identifying the unique bit sequence, the spatial component and a signal components; encoding the unique bit sequence and the spatial component by grouping the transmitters into transmitter groups such that the transmitters in each group have a maximum spatial separation relative to one another to thereby form an encoded signal; decoding the encoded signal to identify the transmitter from which the transmitted bits were transmitted by determining the transmitter location from the or each group. The method preferably comprises trellis coded spatial modulation. Also, a corresponding system is disclosed, the system comprising an encoder for encoding the unique bit sequence and the spatial component identified and received from the transmission array, the encoding including grouping the transmitters into transmitter groups such that the transmitters in each group have a maximum spatial separation relative to one another to thereby form an encoded signal. The system preferably uses trellis coded spatial modulation.

### FIELD OF THE INVENTION

The present invention relates to communication systems. More particularly, the present invention relates to a novel and improved system and method to enhance the performance of communication systems employing multiple transmitter and receiver elements sometimes referred to as multiple input multiple output (MIMO) systems.

### BACKGROUND OF THE INVENTION

Wireless radio frequency channels generally pose several challenges on the system design. The physical layer of such systems has to deal with multipath propagation, interference and limited available spectrum. MIMO (multiple-input-multiple-output) transmission technology constructively exploits multipath propagation to provide higher data throughput for the same given bandwidth.

One of the most promising MIMO techniques to achieve the expected high data rate is a proposed V-BLAST (vertical Bell Labs layered space-time) architecture. In V-BLAST, the information bit stream is separated into substreams. All the symbols of a certain stream are transmitted through the same antenna (one stream per antenna). The substreams are co-channel signals, that is, they have the same frequency band. Therefore, as compared to a SISO (single-input-single-output) system, a linear increase of the data rate with the number of transmit antennae is achieved. The major task at the receiver is to resolve the inter-channel-interference (ICI) between the transmitted symbols. There are several detection algorithms available for V-BLAST. The optimum solution is to use a maximum likelihood (ML) decoder using an ML algorithm. The problem with an ML algorithm is the high complexity required to search all possible combinations. Therefore, other algorithms are proposed to attempt to achieve similar performance to ML detection but with a significant reduction in receiver complexity. A potential technique is the proposed sphere decoder algorithm in which the number of possible codewords is limited by considering only those codewords that are within a sphere centered at the received signal vector. The complexity of separating these signals is small enough that the overall complexity of the sphere decoding is lower than that of a full search. Traditional MIMO systems use all transmit antennae to simultaneously transmit data to the receiver side. The aim is to improve power efficiency by maximizing spatial diversity, or to boost the data rate by transmitting independent streams from each transmit antenna (as in V-BLAST), or to achieve both of them at the same time at the expense of increasing complexity.

An alternative multiple antenna transmission technique, called spatial modulation, utilizes the multiple transmission antennae in a different way. Multiple antennae are considered as additional constellation points that are used to carry information bits as seen in FIG. 1. The spatial constellation point data is shown inside brackets in the figure. In this example 4-PSK and four transmit antennae are considered. Each spatial constellation point defines an independent complex plane of signal constellation points. For illustration purpose, two such planes, for the sequences (00) and (11), are shown in the figure.

At one time instant, only one transmission antenna is active. Part of the incoming bit sequence determines the active antenna. The active antenna transmits the data symbol and both the transmitted symbol and the active antenna index are estimated at the receiver and used to decode the original information bits.

Trellis coded modulation (TCM) is a modulation scheme which allows highly efficient and reliable digital transmission without bandwidth expansion or data rate reduction. TCM combines the function of a convolutional encoder of rate R=k/(k+1) and M-ary signal mapper that maps M=2(k+1) constellation points.

### OBJECTS OF THE INVENTION

One object of the present invention is to provide a method and system that overcomes at least some of the problems associated with the prior art.

A further object of the present invention is to improve spectral efficiency for varying channel conditions.

### SUMMARY OF THE INVENTION

According to one aspect of the present invention there is provided a method of spatial modulation to identify a transmitter within a transmission array, wherein the transmitter has a unique bit sequence and defines a spatial component indicative of relative location; the method comprising: receiving transmitted bits from the transmission array and identifying the unique bit sequence, the spatial component and a signal components; encoding the unique bit sequence and the spatial component by grouping the transmitters into transmitter groups such that the transmitters in each group have a maximum spatial separation relative to one another to thereby form an encoded signal; decoding the encoded signal to identify the transmitter from which the transmitted bits were transmitted by determining the transmitter location from the or each group.

Preferably, the encoding includes trellis encoding.

Advantageously the method further includes error correcting steps, such as for example using a Viterbi decoder, a recursive decoder or any other appropriate decoder.

In an embodiment of the invention the signal component is combined with the encoded signal prior to encoding and is further identified as part of the decoding step.

According to a second aspect of the present invention, there is provided a spatial modulator to enable identification of a transmitter within a transmission array of transmitters, wherein the transmitter has a unique bit sequence and defines a spatial component indicative of relative location; the system comprising: an encoder for encoding the unique bit sequence and the spatial component identified and received from the transmission array, the encoding including grouping the transmitters into transmitter groups such that the transmitters in each group have a maximum spatial separation relative to one another to thereby form an encoded signal.

According to a further aspect of the present invention there is provided a spatial modulator including a decoder for decoding an encoded signal to identify the transmitter from which the transmitted bits were transmitted by determining the transmitter location from one or more transmitter groups wherein the transmitters in the group have a maximum spatial separation relative to one another.

Preferably the transmitters could include radio frequency antennae or other signal emitters, such as loudspeakers, ultrasound transmitters, multiple LEDs (light emitting diodes), etc.

The transmitter groups are ideally produced such that the spatial constellation points within the elements of each set have the maximum possible free physical distance between each other. This will enable an enhanced likelihood of the correct antenna being estimated at the receiver end of the process.

In one embodiment of the present invention the encoding process is carried out by processing matrices. It will be appreciated to the person skilled in the art that other forms of encoding process are equally valid in the context of the present invention.

It will be appreciated that the present invention can be applied at the transmission end and receiving end of a system and that individual modules for the transmission end and the receiving end may exist independently.

The system and method have been described with respect to hardware implemented examples, it will be appreciated that all the system elements and method steps could equally well be implemented by means of appropriate software.

Unlike conventional coding techniques only certain sequences of successive constellation points are allowed with TCM. A key idea is to group symbols into sets of equal sizes where each set maximizes the free distance between its symbols.

Spatial modulation is a radically different and relatively new MIMO approach. It has the important feature that it fully avoids inter-channel interference while it still enables the system to benefit from spatial multiplexing gains. A key to achieving this goal is the exploitation of the relative dislocation of the antennae within an antenna array. This dislocation is used to implicitly convey extra data bits. At the receiver a new block, namely an antenna detector, is required. The use of trellis coded modulation (TCM) for the correction of data errors that occur within the antenna detector block, i.e. the correction of erroneous data bits that are implicitly encoded into the location of the antenna, is a further significant advantage of the present invention.

The TCM concept is adopted in a novel way to combat the performance degradation of spatial modulation in correlated channel conditions. TCM is applied to the spatial constellation points of spatial modulation. In the proposed trellis coded spatial modulation (TCSM), only certain sequences of successive spatial constellation points are allowed which reduces the correlation between neighboring antennae. When TCSM performance is compared to the performance of spatial modulation and V-BLAST major performance improvements are demonstrated particularly in non-ideal channel conditions. As a consequence, the proposed TCSM allows the integration of a multiple antennae system in small devices with antennae separations as low as 0.1λ. It is also suitable for indoor applications with direct LoS (line of sight) between transmitters and receivers—a scenario where traditional spatial multiplexing techniques have failed.

### DESCRIPTION OF THE DRAWINGS

Reference will now be made by way of example, to the accompanying drawings, in which:

FIG. 1 is a prior art diagram showing a sequence of bits converted into a signal constellation and into a spatial constellation point.

FIG. 2 is a trellis coded spatial modulation (TCSM) system model, in accordance with one embodiment of the present invention, by way of example.

FIG. 3 is a diagram showing a trellis coded encoder, spatial constellation mappings, and state transitions of the TCM encoder, in accordance with one embodiment of the present invention, by way of example.

FIG. 4 is a diagram of V-BLAST system model, in accordance with one embodiment of the present invention, by way of example.

FIG. 5 is a graph showing a performance comparison of spatial modulation 4×4 BPSK and TCSM 4×4 4QAM for an ideal channel, in accordance with one embodiment of the present invention, by way of example.

FIG. 6 is a graph showing a performance comparison of spatial modulation 4×4 BPSK and TCSM 4×4 4QAM in a Rician fading channel with a Rician K-factor of 3, in accordance with one embodiment of the present invention, by way of example.

FIG. 7 is a graph showing a performance comparison of spatial modulation 4×4 BPSK and TCSM 4×4 4QAM in a spatial correlation channel with transmission antenna element spacing of 0.1λ at the transmitter and 0.5λ at the receiver, in accordance with one embodiment of the present invention, by way of example.

FIG. 8 is a graph showing a performance comparison of TCSM and V-BLAST in ideal channel conditions, in accordance with one embodiment of the present invention, by way of example.

FIG. 9 is a graph showing a performance comparison of TCSM and V-BLAST in a Rician fading channel with a Rician K-factor of 3, in accordance with one embodiment of the present invention, by way of example.

FIG. 10 is a graph showing a performance comparison of TCSM and V-BLAST in a spatial correlation channel with transmission antenna element spacing of 0.1λ and receiver antenna element spacing of 0.5λ, in accordance with one embodiment of the present invention, by way of example.

### DESCRIPTION

The present invention extends the design of transmission systems which employ Spatial Modulation (SM) by incorporating Trellis Coded Modulation (TCM) into the antenna selection process with appropriate receiver decoders to improve the overall system performance, for example in multipath fading environments and when small antenna spacing (for example in mobile phones) results in detrimental spatial correlation effects.

In this invention a key idea of TCM is applied to the antenna constellation points of spatial modulation. This novel scheme is called trellis coded spatial modulation (TCSM). In TCSM, the transmission antennae are partitioned into sub-sets in such a way that the spatial spacing between antennae in the same sub-set is maximized. Therefore, the effect of correlated channels on the performance of spatial modulation is reduced. This fact is significant when considering portable devices with multiple antennae installed in compact environments where enough separation between them cannot be guaranteed. The performance of the proposed idea is analyzed in the presence of Rician fading and spatial correlation (SC) channels and major enhancements in BER are reported as compared to spatial modulation and V-BLAST with the same spectral efficiency.

A key idea is to group the spatial constellation points into sets with the elements of each set having the maximum possible free physical distance between each other in order to enhance the likelihood that the correct antenna is estimated. The incoming data bits determine the active transmitter (within an array) and the signal constellation point (from a complex signal plane) transmitted from it. At the receiver side, the active transmitter index and the transmitted symbol are estimated and used together to decode the transmitted information bits. Trellis coded modulation (TCM) is applied to enhance the bit error ratio (BER) performance of bits encoded into the physical location of an antenna. For the same spectral efficiency and for idealistic channel conditions, TCSM performs almost the same as pure spatial modulation and V-BLAST. However, a significant enhancement is found for non-ideal channel channel conditions such as Rician fading and spatial correlation (SC) among the transmitter and receiver elements.

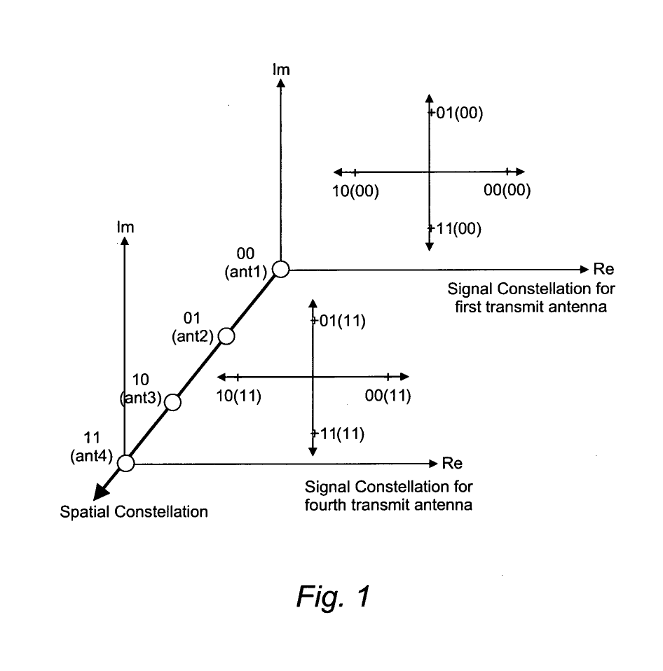

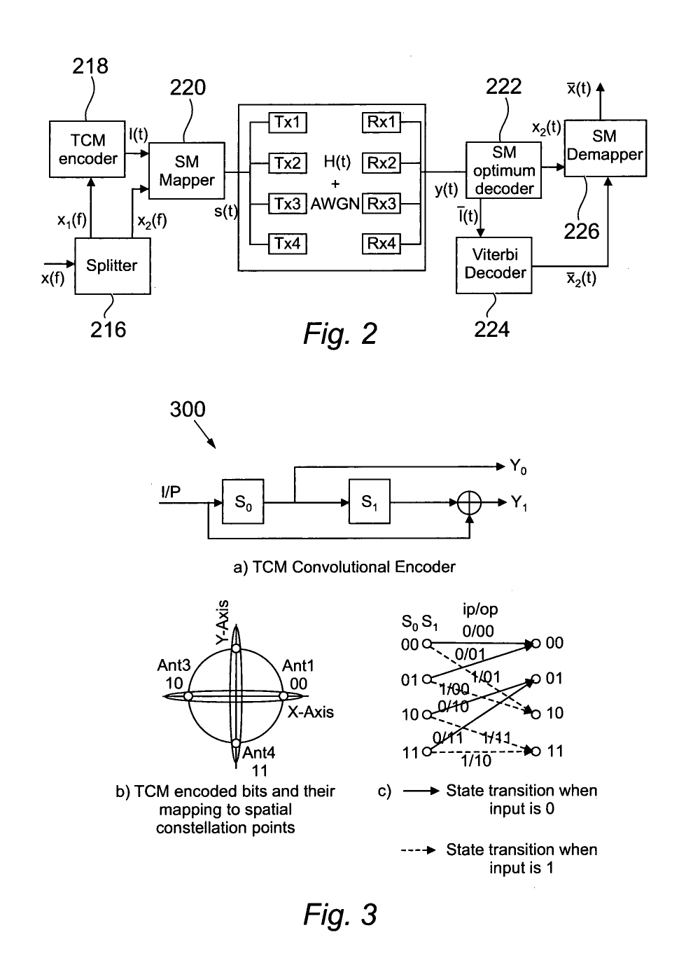

This invention targets the above problems and also the problems of forward error correction (FEC) coding for spatially encoded information by using the proposed TCSM system model as depicted in FIG. 2. A MIMO system consisting of four transmit antennae (not shown), (Nₜ=4) and four receive antennae (not shown), (Nᵣ=4) as an example. Clearly other numbers of antennae and receivers could equally be used. The system also includes at the transmitter side, a splitter 216, a TCM encoder 218 and a spatial modulation mapper 220. Similarly, at the receiver side a spatial modulator optimum decoder 222 is included along with a decoder 224 (e.g. a Viterbi decoder) and a spatial modulator demapper 226. The transmitted bits at each time instant are grouped as the row vectors of the matrix x(t). For illustration purposes, the incoming bit sequences are considered x(t)=[001 110 111]^{T} where (•)^{T} denotes the transpose of a vector or a matrix. The first step is to split this matrix into two matrices. The first matrix x₁ (t) contains the bits that are mapped to spatial constellation points. While the second matrix contains the bits that are mapped to signal constellation points. Accordingly, in the considered example, x₁ (t)=[0 1 1]^{T} and x₂ (t)=[01 10 11]^{T}. Assuming a 4-PSK (phase shift keying) constellation, as seen in FIG. 1, the second matrix is mapped to [i−1−i]^{T}, where each element in this matrix corresponds to the symbol that is transmitted from one antenna among the set of existing transmission antennae at one time instant. The first matrix, x₁ (t), is then used to select the active transmission antenna. However, before mapping the bits in the first matrix to the spatial constellation points (also know as the transmit antenna indexes), the bits are processed by a half rate TCM encoder. The TCM encoder block 300 consists of a convolutional encoder followed by a random block interleaver. The TCM encoder, state transition, and spatial mapping are depicted in FIG. 3. The TCM groups the antenna indexes in a tree like fashion, then separates them into two limbs of equal size. At each limb of the tree, the indexes are further apart. In other words, the TCM partitions the transmit antennae into sub-sets with the constraint of maximizing the spacing of antennae belonging to the same sub-set. Other schemes may be used to separate the antennae and form the sub-sets. In the given example and assuming all antennae are equally spaced on a vertical line, antennae one and three in FIG. 3b form a set and antennae two and four in FIG. 3b form the other set. The output of the TCM encoder is then used to select the active antenna. In the above example, x1(t) is transformed into another matrix l(t)=[00 01 11]^{T} by the encoder of FIG. 3(c) assuming the initial state of the encoder is 00. The spatial modulation mapper operates on both l(t) and x₂(t) matrices creating the output matrix below.

$$s ( t ) = [ \begin{matrix}i & 0 & 0 \\ 0 & - 1 & 0 \\ 0 & 0 & 0 \\ 0 & 0 & - i\end{matrix} ] .$$

Each column from the output matrix is transmitted at a single time instant from the existing transmit antennae over the MIMO channel H(t). At the first time instant in the considered example the elements of the first column are transmitted from the four transmit antennae. At different time instances different elements are transmitted. Since only one element is different from zero, only one antenna emits a signal. This means, that only the first antenna is active at a particular time instant and is transmitting symbol i while all other antennae are switched off. The signal experiences an Nᵣ-dim additive white Gaussian noise (AWGN). The channel and the noise are assumed to have independent and identically distributed (iid) entries according to CN(0,1).

At the receiver, an algorithm is in place which estimates the actual transmitter (e.g. the antenna number) which emitted energy at a given time instant. The estimated antenna number is de-mapped to the corresponding bits and the incoming data sequence of one complete frame is applied to a random block de-interleaver and then decoded using a hard decision Viterbi decoder 224. The output from the Viterbi decoder together with the estimated symbols are used to retrieve the original information bits.

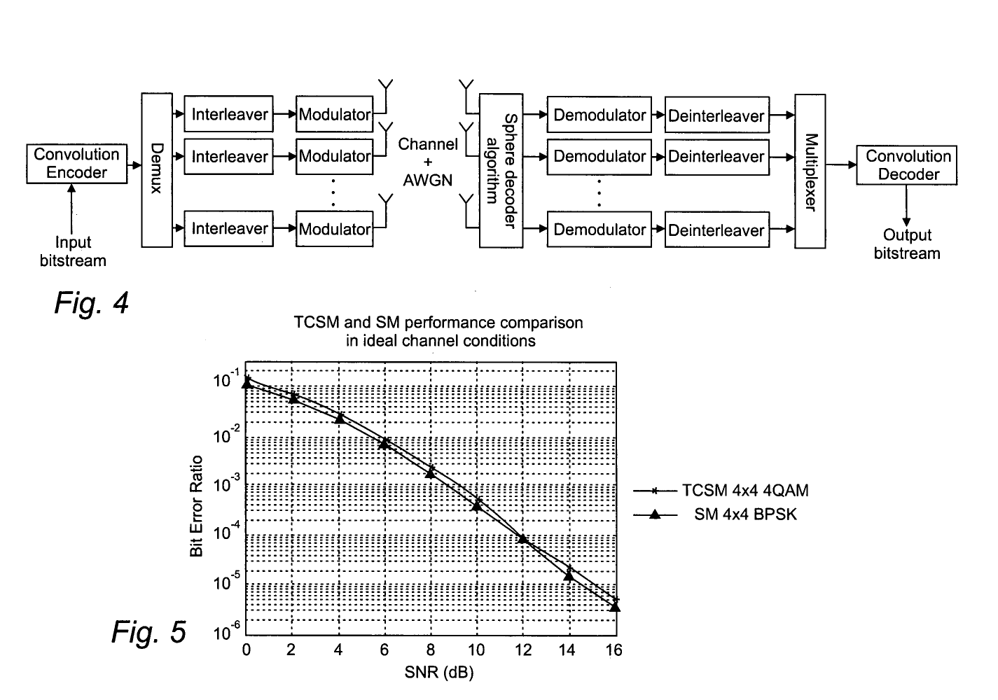

The performance of TCSM scheme will now be compared to spatial modulation and V-BLAST to illustrate some of the improvements with the TCSM scheme. Firstly the spatial modulation and V-BLAST configuration will be discussed in greater detail. Spatial modulation applies no channel coding and uses a smaller number of transmission antennae or lower modulation order to achieve the same spectral efficiency as the TCSM. V-BLAST system model is discussed below with reference to FIG. 4. The half rate convolutional encoder shown in FIG. 3 is considered and the coded V-BLAST system is generally termed horizontal BLAST (H-BLAST). In H-BLAST, the incoming bit stream is demultiplexed into Nₜ parallel substreams. Channel coding followed by interleaving is applied to each substream. The coded bits are then modulated and transmitted from the corresponding transmission antenna. If the interleaving depth is selected to be larger than the coherence time of the channel, additional diversity gain can be achieved.

Another way of applying channel coding to V-BLAST is to use a single channel code for all layers as shown in FIG. 4. This scheme is called single coded BLAST (SCBLAST). SCBLAST is simpler than H-BLAST in the sense that only a single channel encoder is needed for all layers. In addition, in correlated slow or block fading channels, SCBLAST outperforms H-BLAST since the demultiplexer (at the transmitter) and multiplexer (at the receiver) act as spatial interleavers thereby breaking some of the correlation in the received signal. Correlated slow fading channels are optional in the TCSM scheme and therefore, SCBLAST is considered for the comparisons. It will be appreciated that although the following examples all refer to H-BLAST they could equally apply to SCBLAST.

At the receiver, an SD algorithm is employed to detect the transmitted symbols from all layers. In simulations, the SD algorithm based on integer lattice theory is implemented. A complex MIMO system is decoupled into its real and imaginary parts so as to form an equivalent real-valued system. This approach is most appropriate for lattice-based modulation schemes such as quadrature amplitude modulation (QAM) or pulse amplitude modulation (PAM). For other complex constellations such as phase-shift keying (PSK), the SD based on integer lattice theory are inefficient due to the existence of invalid candidates. A solution is to avoid decoupling of the complex system by applying complex SD algorithms.

The use of the SD algorithm avoids an exhaustive search by examining only those points that lie inside a sphere with radius C. The performance of the SD algorithm is closely tied to the choice of the initial radius. The radius should be chosen large enough so that the sphere contains the solution. However, the larger the radius is, the longer the search takes which therefore increases the complexity. On the other hand, a small radius may cause the algorithm to fail to find any point inside the sphere. In accordance with the present invention, the initial radius of the SD algorithm is adjusted according to the noise level assuming knowledge of the signal to noise ratio (SNR) at the receiver side. If no point is found inside the sphere, the search is repeated with a sphere of larger radius (C=C+1). This approach can perform a near optimum maximum likelihood detection.

SD receivers have been implemented in custom application-specific integrated circuits (ASICs) and as simplified fixed complexity designs have conveniently been realized in field-programmable gate arrays (FPGAs). The output symbols from SD are demodulated and the bits are de-interleaved. The bits from all layers are multiplexed and hard decision Viterbi decoder is then applied.

At the receiver, an optimum spatial modulation decoder is proposed to estimate the transmitted symbol \tilde{x}₂(t) and the transmit antenna index \tilde{l}(t) as follows:

$$\begin{matrix}[ {\tilde{x}}_{2} , \tilde{l} ] = {arg}_{{\tilde{x}}_{2} \tilde{l}} max {p}_{y} ( y \vert {s}_{l , m} , H ) \\ = {arg}_{{\tilde{x}}_{2} \tilde{l}} max \sqrt{ρ} {‖ {g}_{l , m} ‖}_{𝔽}^{2} - 2 Re \{ {y}^{H} {g}_{l , m} \} ,\end{matrix}$$

where g_{l,m}=h_{isl,m} is the received vector when transmitting the symbol sl,m from antenna index l where 1≦l≦Nt and 1≦m≦M and hₗ is the channel vector containing the channel path gains from transmission antenna/to all receiving antennae; M is the size of the signal constellation diagram and Re is the real part of a complex number. In addition, ρ is the average signal to noise ratio (SNR) at each receive antenna, and

ρ_{y}(y|s_{l,m},H)=π^{-N}^{ₜ}exp(−∥y−\sqrt{ρ}Hs_{l,m}∥_{F}²) (2)

is the probability density function (pdf) of y conditioned on the transmitted symbol sl,m from antenna index l and the channel H. The notation ∪·∪_{F} stands for the Frobenius norm of a vector or a matrix.

Rician fading and Kronecker spatial correlation (SC) channel models may also be considered. The complete models for the channel with Rician fading and spatial correlation are now discussed. H is an Nᵣ×Nₜ flat fading channel matrix representing the path gains hᵢⱼ between transmission antenna j and receiving antenna i.

$$H ( t ) = [ \begin{matrix}{h}_{11} & {h}_{12} & … & {h}_{1 {N}_{t}} \\ {h}_{21} & {h}_{22} & … & {h}_{2 {N}_{t}} \\ ⋮ & ⋮ & ⋱ & ⋮ \\ {h}_{{N}_{r} 1} & {h}_{{N}_{r} 2} & … & {h}_{{N}_{r} {N}_{t}}\end{matrix} ] \qquad ( 3 )$$

In the case of non-line-of-sight (NLOS), the sum of all scattered components of the received signal are modeled as a zero mean complex Gaussian random process given by α(t)=α₁(t)+⊕(−1α₂(t)), where α₁(t) and α₂(t) are assumed to be real valued statistically independent Gaussian random processes. As a result, the phase of the random process α(t) takes a uniform distribution and the amplitude takes a Rayleigh distribution. Therefore, a static fading Rayleigh channel matrix that is flat for all frequency components can be modeled.

If a line of signal (LOS) path exists between the transmission and receiving antennae, the channel amplitude gain is characterized by a Rician distribution and the channel is said to exhibit Rician fading. The Rician fading MIMO channel matrix can be modeled as the sum of the fixed LOS matrix and a Rayleigh fading channel matrix as follows:

$${H}_{Ricean} ( t ) = \sqrt{\frac{K}{1 + K}} \overline{H} ( t ) + \sqrt{\frac{1}{1 + K}} H ( t ) ,$$

where ⊕K/(k+1) \tilde{H} is the LOS component, ⊕K/(k+1) H is the fading component,
and K is the Rician K-factor. The Rician K-factor is defined as the ratio of the LOS and the scatter power components and H is a matrix with all elements being one.

In the case of the spatial correlation (Kronecker model), the channel correlation depends on both the environment and the spacing of the antennae elements. It is assumed that correlations at the transmitter and receiver array are independent of each other because the distance between the transmitter and receiver array is large compared to the antennae element spacing.

To incorporate the spatial correlation into the channel model, the correlation among channels at multiple elements needs to be calculated. The correlated channel matrix is then modeled using the Kronecker model.

H^{corr}(t)=Rᵣₓ^{1/2}H(t)Rₜₓ^{1/2}

The correlation matrices are computed analytically based on a power azimuth spectrum (PAS) distribution and array geometry. A clustered channel model, in which groups of scatterers are modeled as clusters located around the transmission and receive antennae, is assumed. The clustered channel model is validated through measurements and has been adopted by various wireless system standard bodies such as the IEEE 802.11n Technical Group (TG) and the 3GPP/3GPP2 Technical Specification Group (TSG).

In order to validate and compare the TCSM scheme of the present invention, Monte Carlo simulation results for at least 10⁶ channel realizations are obtained and the average bit error ration (BER) is plotted versus the average SNR at each receiver input. In all simulations where Rician fading is considered, channel correlation due to antenna spacing is zero, but the Rician K factor is set to K=3. This value is within the range of the measured values in indoor wireless communication. For the spatial correlation channel model, various parameters are adopted including setting the element spacing at the transmitter and the receiver to 0.1λ and 0.5λ, respectively. The 0.5λ separation between the antennae can achieve relatively low correlation assuming the receiver is surrounded by a large number of local scatterers. The 0.1λ element spacing at the transmitter results in high correlation which models a small mobile device with multiple antennae where large separation between the antennae cannot be achieved. The first results, depicted in FIGS. 5, 6 and 7, show TCSM performance under ideal, Rician fading, and SC channel conditions respective to spatial modulation performance under similar channel conditions. TCSM transmits 4QAM symbol from a 4×4 MIMO system and applies the half rate TCM encoder. Therefore, TCSM achieves 4 b/s/Hz but only 3 bits are data bits and the fourth one is a coding bit. SM transmits a BPSK symbol from a 4×4 MIMO system achieving 3 b/s/Hz spectral efficiency. Thus, the two systems have virtually the same spectral efficiency.

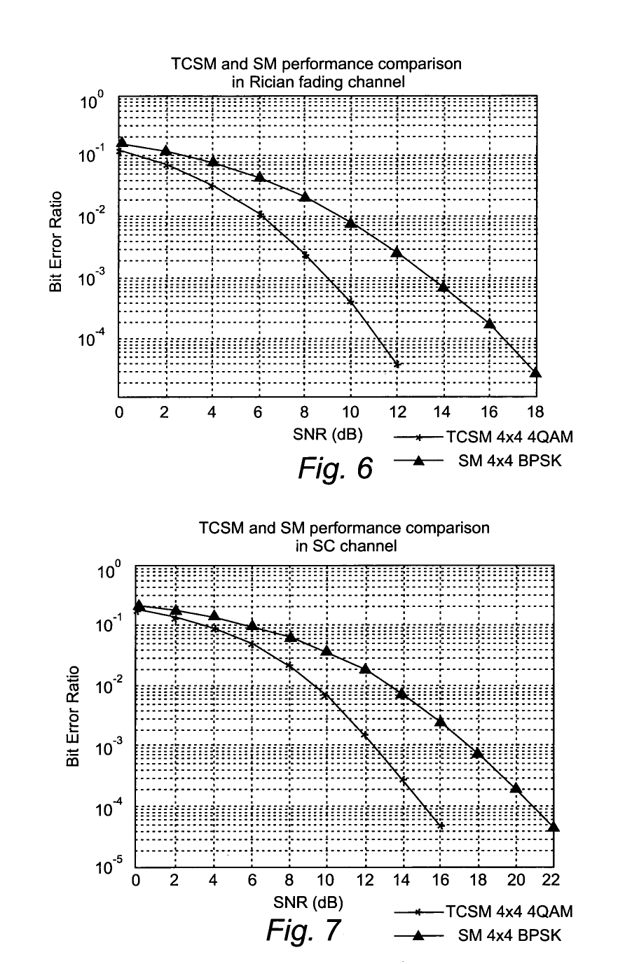

In ideal channel conditions where the channel paths are uncorrelated, the BER of the two systems are compared in FIG. 5. Spatial modulation performs slightly better than TCSM as the TCM coding gain and the set partitioning of the transmission antennae has no advantage in this case since all channel paths are uncorrelated. However, the situation is different if correlated channel paths are considered, i.e. when Rician fading and spatial correlation channels are considered. The considerable advantage of the TCSM scheme over spatial modulation scheme is obvious from FIGS. 6 and 7. A SNR gain of about 6 dB in Rician fading channel at a BER of 10⁻⁴ can be seen in FIG. 6. In addition, a similar gain in SNR at the same BER is depicted in FIG. 7 for the SC channel. The significant gains in the presence of channel correlations due to Rician fading or SC can be attributed to the TCM encoding and the underlying partitioning of the transmission antennae. The fact that the transmission antennae with larger separation distance are grouped in one set, reduces the effect of correlation and results in a better performance.

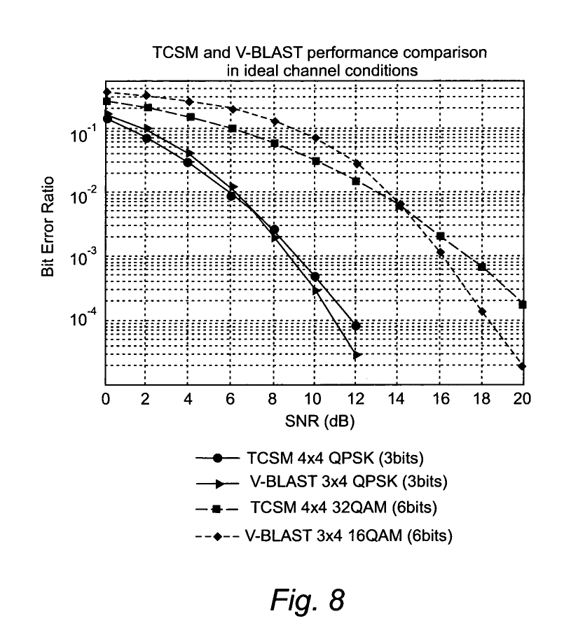

In the second set of results, the BER of TCSM and V-BLAST are compared in ideal, Rician fading, and SC channel conditions as depicted in FIGS. 8, 9, and 10, respectively. Two spectral efficiencies are studied for each system. TCSM transmits 4QAM 32QAM symbols from 4×4 MIMO system achieving spectral efficiency of 3 b/s/Hz and 6 b/s/Hz, respectively. The V-BLAST system transmits 4QAM and 16QAM symbols from a 3×4 MIMO system and applying the half rate channel encoder, achieves 3 b/s/Hz and 6 b/s/Hz spectral efficiencies, respectively.

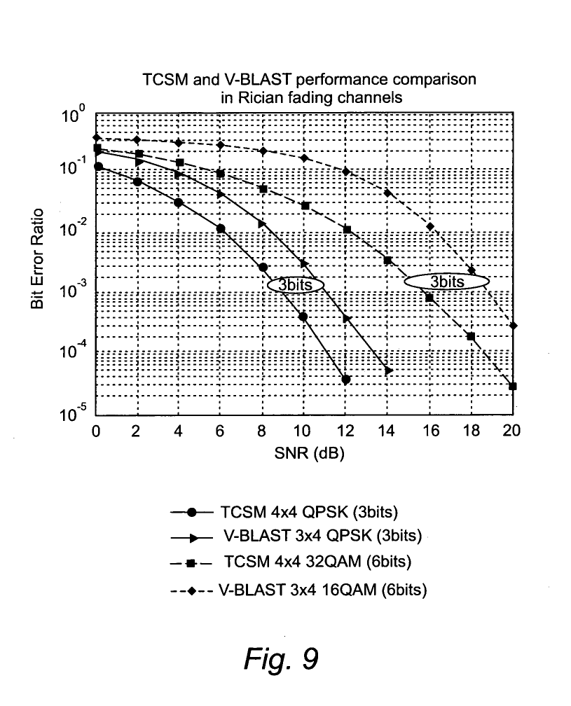

In ideal channel condition, the TCSM and V-BLAST schemes outperform each other in a range of SNRs. The BER curves intersect at 7 dB for 3 b/s/Hz and at 14 dB for 6 b/s/Hz as shown in FIG. 8. The channel coding gain in V-BLAST causes BER enhancements at high SNR. In addition, and as discussed previously, the effect of TCM coding and set partitioning are insignificant as the channel paths are uncorrelated in this scenario. The BER gain of V-BLAST over TCSM at high SNR is larger for the case of 6 b/s/Hz. This is mainly because the higher coding gain of V-BLAST at high SNR and the fact that TCSM uses higher order modulation in order to achieve similar spectral efficiency to V-BLAST. The improvements of TCSM over V-BLAST at low SNR is not related to the TCM coding and set partitioning. It is mainly due to the underlying working mechanism of spatial modulation and the fact that it completely avoids inter-channel-interference (ICI) at the receiver side. In FIG. 9, the performance of V-BLAST and TCSM is compared in the presence of a line of sight (LOS) path between the transmitter and the receiver (Rician fading channel). Rician fading enhances the SNR at the receiving antenna, but increases the correlation between the antenna elements. Therefore, Rician fading significantly degrades the performance of V-BLAST and spatial modulation. This degradation can be observed for V-BLAST in the results depicted in FIG. 9. As compared to the obtained results in the ideal channel conditions, V-BLAST requires 2 dB and 3 dB increase in SNR to achieve a BER of 10⁻³ for 3 b/s/Hz and 6 b/s/Hz, respectively. However, TCSM seems to be less affected by the presence of Rician fading. In fact, it demonstrates even better performance as compared to the ideal channel condition results. For instance, the 32QAM 4×4 TCSM achieves a BER of 10⁻³ at a SNR of about 19 dB in ideal channel conditions. Though, it achieves the same BER at a SNR of 16 dB in the presence of Rician fading channel. Indeed, TCSM demonstrates better performance in the presence of LOS path between the transmitter and the receiver. This can be explained by the fact that Rician fading increases the SNR at the receiver side and the underlying set partitioning together with TCM coding eliminates the correlation between transmission antennae. Nevertheless, it should be mentioned that the performance of TCSM in Rician fading channels depends on the number of transmission antenna, the considered modulation order, and the Rician K-factor. However, for the systems according to the present invention and, for example, in the presence of Rician fading, TCSM outperforms V-BLAST by 2 dB and 3 dB in SNR at a BER of 10⁻³ for 3 b/s/Hz and 6 b/s/Hz, respectively.

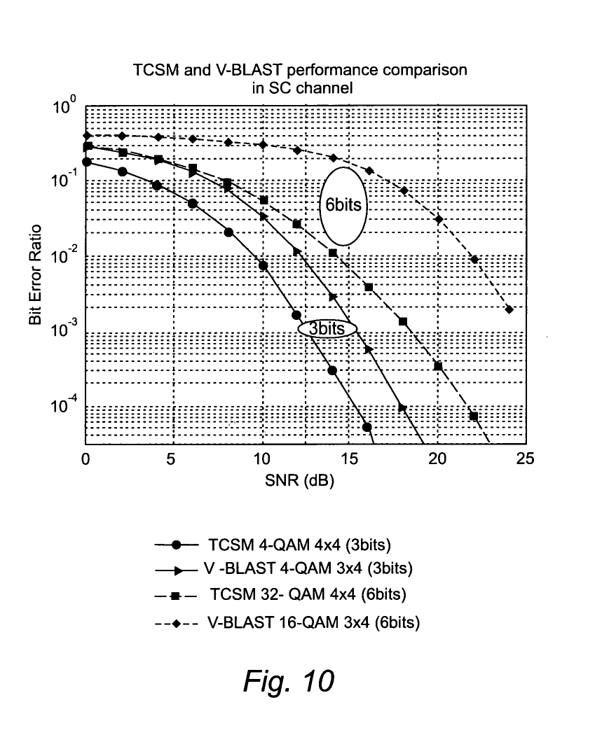

The effect of SC on the performance of TCSM and V-BLAST has also been studied and the results are shown in FIG. 10. The presence of correlation degrades the performance of the two systems. Again, TCSM is significantly less affected by the presence of spatial correlation when compared to V-BLAST. As compared to the results obtained in ideal channel conditions, SC degrades the performance of TCSM by 3 dB and 1 dB in SNR at a BER of 10⁻³ for 3 b/s/Hz and 6 b/s/Hz, respectively. While V-BLAST system performance degrades by about 5 dB and 9 dB in SNR at a BER of 10⁻³ for 3 b/s/Hz and 6 b/s/Hz, respectively. TCSM outperforms V-BLAST by about 3 dB and 6 dB in SNR at a BER of 10⁻³ for 3 b/s/Hz and 6 b/s/Hz, respectively.

The basic idea of the proposed scheme is to divide the existing antennae into sets using TCM such that each set maximizes the spatial distance between its antenna and therefore minimizes the effect of correlation fading thereon.

It will be appreciated that this invention may be varied in many different ways and still remain within the intended scope and spirit of the invention.

1. A method of spatial modulation to identify a transmitter within a transmission array, wherein the transmitter has a unique bit sequence and defines a spatial component indicative of relative location; the method comprising:
receiving transmitted bits from the transmission array and identifying the unique bit sequence, the spatial component and a signal components;
encoding the unique bit sequence and the spatial component by grouping the transmitters into transmitter groups such that the transmitters in each group have a maximum spatial separation relative to one another to thereby form an encoded signal; and
decoding the encoded signal to identify the transmitter from which the transmitted bits were transmitted by determining the transmitter location from the or each group.

2. A method according to claim 1, wherein the encoding includes trellis encoding.

3. A method according to claim 1, further comprising error correcting steps, in particular using a Viterbi decoder, a recursive decoder or any other appropriate decoder.

4. A method according to claim 1, wherein the signal component is combined with the encoded signal prior to encoding and is further identified as part of the decoding step.

5. A system to enable identification of a transmitter within a transmission array of transmitters, wherein the transmitter has a unique bit sequence and defines a spatial component indicative of relative location; the system comprising:
an encoder for encoding the unique bit sequence and the spatial component identified and received from the transmission array, the encoding including grouping the transmitters into transmitter groups such that the transmitters in each group have a maximum spatial separation relative to one another to thereby form an encoded signal.

6. A system according to claim 5, wherein the encoder comprises at least one processing matrix.

7. A spatial modulator including a decoder for decoding an encoded signal to identify the transmitter from which the transmitted bits were transmitted by determining the transmitter location from one or more transmitter groups wherein the transmitters in the group have a maximum spatial separation relative to one another.

8. A spatial modulator according to claim 7, wherein the transmitters comprise radio frequency antennae or other signal emitters, in particular loudspeakers, ultrasound transmitters and/or multiple light emitting diodes.

9. A spatial modulator according to claim 7, wherein each spatial constellation point defines an independent complex plane of signal constellation points, and wherein the transmitter groups are produced such that spatial constellation points within elements of each transmitter group have the maximum possible free physical distance between each other.
